(19) United States
(12) Patent Application Publication
(10) Pub. No.: US 2002/0085219 A1
(43) Pub. Date: Jul. 4, 2002

(54) Method of and system for generating and viewing multi-dimensional images

(76) Inventor: Victor Ramamoorthy, Pleasenton, CA (US)

Correspondence Address: Mark G. Lappin, Esq., P.C., McDERMOTT WILL & EMERY, 28 State Street, Boston, MA, 02109-1775, US

(21) Appl. No.: 09/929,304

(22) Filed: Aug. 13, 2001

Related U.S. Application Data
(60) Provisional application No. 60/224,829, filed on Aug. 11, 2000.

(51) Int. Cl. B41J 1/00; G06F 15/00

(52) U.S. Cl. 358/1.9

(57) ABSTRACT

A system for generating, at a client location, an image representative of a view of an object, includes:

A. an image capture system for generating a plurality of image data sets associated with an object at an image capture location, each of the image data sets being representative of an image of the object as viewed from an associated image capture viewing angle;

B. an image processor for transforming the image data sets to a matrix data set, the matrix data set being representative of the plurality of image data sets;

C. a client processor;

D. means for transmitting the matrix data set to the client processor, wherein the client processor is responsive to a user specification of a user-specified viewing angle, for generating client view data from the matrix data set, wherein the client view data is representative of an image of the object viewed from the user-specified viewing angle; and

E. a client display at the client location responsive to the client view data to display the object.

### CROSS REFERENCES TO RELATED APPLICATIONS

This application claims the benefit of priority from commonly owned U.S. Provisional Patent Application Ser. No. 60/224,829, filed Aug. 11, 2000, entitled METHOD OF AND SYSTEM FOR GENERATING AND VIEWING MULTI-DIMENSIONAL IMAGES.

### FIELD OF THE INVENTION

The present invention relates generally to a method of and system for generating and viewing multi-dimensional images, and more particularly to a method of and system for capturing a plurality of successive images of an object and transmitting the images to a viewer to provide a multi-dimensional image of the object.

### BACKGROUND OF THE INVENTION

As the global internet expansion continues, more and more companies are using the internet as a medium to sell various products and services. The internet provides a convenient platform on which to exchange information and enable business transactions between consumers, retailers, manufacturers and suppliers. Retailers, manufacturers and suppliers typically maintain product information on their websites that are conveniently accessible by potential consumers of the products. Internet transactions typically involve the sale of goods and services among businesses or between businesses and consumers.

A typical transaction begins when a potential customer of a product enters the website of an e-tail server system of a retailer, manufacturer or supplier and views the textual and visual information about the product. Most of the e-tail server system websites include a textual description of a product and a small, compressed image of the product. For many consumers, visualizing and inspecting the product from the compressed image can be difficult, due to the small amount of information contained in these images. One solution to this problem is to provide many images of the product for the consumer to view. However, this increase in the amount of data being transmitted to the consumer typically results in slower transmission times, which can frustrate the consumer and cause him or her to shop elsewhere.

One prior art approach to providing useful visual data to a consumer is to create a three-dimensional model of the product. This is done by scanning the product with a 3D scanner and transmitting the scanned data to the consumer, where the model is constructed and the resulting image is presented to the consumer. However, three-dimensional modeling is extremely labor-intensive and expensive, and 3D models require densely packed graphical model data, which increases the bandwidth requirement to transmit the data. Furthermore, the lack of clarity and resolution in current 3D models renders the images synthetic-looking, most consumers' computers do not have the capability of effectively receiving and constructing 3D images in a timely manner, and, because 3D modeling is a manual process, it does not scale well with a large number of objects.

Another prior art approach is the use of video clips to illustrate the product. However, video clips require increased storage, management and bandwidth, the manual production of video clips is labor-intensive and expensive, and the quality of video clips transmitted over the internet can be poor.

### SUMMARY OF THE INVENTION

The invention provides an automated system for generating multi-dimensional images that enables a server system, such as an e-tail server system, to present data representations of an object in such a way as to provide a recipient, such as a consumer, with high-quality, multi-dimensional product images, using relatively narrow bandwidth transmissions.

The present invention provides images depicting different views of an object (such as a product). For a given object, the invention quickly creates an image set of the object. The system preferably consists of the following components:

A. A spherical scanner which is an opto-mechanical system, precisely controlled by a controller computer system, that can capture many views of an object (e.g., product) placed at an image capture location. Preferably, the image data capture for an object is an automatic process without any need to manual assistance;

B. A processing system which removes the redundancies in the captured data and generates a compact data set called a main image matrix;

C. An image server, which receives the output of the processing system transmitted, for example, over the internet;

D. An imaging editing device which enables the images in each main image matrix to be manipulated to include meta-data such as web links, audio files, video files, OLE objects, etc.; and

E. A client (or customer) processor system, which accesses the stored image data and generates therefrom an image of the object (or product) for viewing.

A transmission system is used with file formats and protocols that enable the image data to be sent over to the client processor for interactive viewing of the product. The system is very flexible and easy to manipulate by the client, so that different views of the product can be generated at the client computer.

The image data preferably contains many views of the product in a compressed form. Once the image data is generated, it can be stored in the image server or servers. The image server can also be the same as the main web page server of the commerce site or a separate server that is linked to the main server.

According to one aspect of the invention, system for generating at a client location, an image representative of a view of an object, includes:

A. an image capture system for generating a plurality of image data sets associated with an object at an image capture location, each of the image data sets being representative of an image of the object as viewed from an associated image capture viewing angle;

B. an image processor for transforming the image data sets to a matrix data set, the matrix data set being representative of the plurality of image data sets;

C. a client processor;

D. means for transmitting the matrix data set to the client processor, wherein the client processor is responsive to a user specification of a user-specified viewing angle, for generating client view data from the matrix data set, wherein the client view data is representative of an image of the object viewed from the user-specified viewing angle; and

E. a client display at the client location responsive to the client view data to display the object.

The user-specified viewing angle may be selected independently of the image capture viewing angles and may coincide with one of the image capture viewing angles. Each of the image capture viewing angles may have coordinates along both a longitudinal axis and a latitudinal axis around the object. The transmitting means effects data transmission over a communication path which may be a wired path, including one of the group consisting of a LAN, a WAN, the internet and an intranet. The communications path may be a wireless path, including one of the group consisting of a LAN, a WAN, the internet, and an intranet. The transmitting means may effect transfer of the matrix data set resident on a storage medium which may be from the group consisting of a hard disk, a floppy disk, CD, a memory chip. The matrix data set may further include multimedia data and/or links to Internet sites associated with the object. The system may further include a matrix controller for effecting the generation of multiple matrix data sets for the object, each of the matrix data sets being representative of a plurality of image data sets generated for the object in a different state. The client processor may include a view generating computer program adapted to control the client processor to generate the client view data from a received matrix data set. The matrix data set may further include at least a portion of the view generation computer program. The matrix processor may effect a compression of the matrix data set prior to transmission to the client processor and the client processor may effect decompression of a received compressed matrix data set. A portion of at least one of the image data sets which is representative of a predetermined surface region of the object may be associated with a predetermined action, the association being defined in the image data sets. The client processor may be operable in response to a user selection of a portion of the displayed image which corresponds to the predetermined surface area of the object, to effect the predetermined action. The predetermined action may be to generate the display based on client view data from a different matrix data set. The matrix data sets may further include non-image data. The non-image data may include data relating to attributes of the object. The non-image data may include data that points the client processor to a database that includes attribute data of the object. The client processor may include means for modifying the predetermined action.

According to another aspect of the invention, a method of determining an optimal focus setting of a camera having a minimum focus setting value fₘᵢₙ and a maximum focus setting value fₘₐₓ to an optimum focus setting value including:

A. setting a focus setting of the camera to the minimum focus setting value fₘᵢₙ;

B. capturing an image of an object with the camera;

C. computing the value of the Y-component of the image;

D. counting the number of pixels along an edge of the Y-component of the image;

E. storing the edge pixel count associated with the image;

F. increasing the focus setting by a predetermined amount Δf;

G. repeating steps B-F until the focus setting equals the maximum focus setting value fₘₐₓ;

H. identifying the image having the greatest edge pixel count; and

I. identifying the focus setting corresponding to the image identified in step H as the optimal focus setting.

According to another aspect of the invention, a method for adjusting the gain of each of a plurality of cameras in an array of cameras aimed at a common point in order to balance the intensity of images captured by each of the cameras in the array includes:

A. capturing an image with each of the plurality of cameras;

B. determining an intensity associated with each image;

C. identifying an image having the highest intensity Iₘₐₓ of the plurality of images and an image having the lowest intensity Iₘᵢₙ of the plurality of images;

D. determining if the difference between Iₘₐₓ and Iₘᵢₙ exceeds an intensity threshold;

E. increasing the gain of the camera that captured the image having the lowest intensity Iₘᵢₙ by a predetermined amount;

F. repeating steps A-E until, in step D, the difference between Iₘₐₓ and Iₘᵢₙ does not exceed the intensity threshold.

According to yet another aspect of the invention, a system for creating a multi-dimensional image includes a plurality of cameras arranged in an array; a turntable device adapted for receiving an object thereon and including a motor for turning the turntable; a camera control device for controlling the cameras; and a motor control device for controlling the operation of the motor. Each of the plurality of cameras captures an image of the object at differing angles of rotation of the turntable to form an X by Y image matrix containing (XY) images, where X represents a number of degrees of rotation of the turntable and Y represents a number of the cameras.

### BRIEF DESCRIPTION OF THE DRAWINGS

The foregoing and other objects of this invention, the various features thereof, as well as the invention itself may be more fully understood from the following description when read together with the accompanying drawings in which:

FIG. 1 is a schematic block diagram of the system for generating and viewing multi-dimensional images;

FIG. 2 is a schematic diagram of an array of cameras in accordance with the present invention;

FIG. 3 is a schematic block diagram of the camera and motor control systems in accordance with the present invention;

FIG. 4 is a flow diagram of the method of focusing the cameras in the array in accordance with the present invention;

FIG. 5 is flow diagram of the method of balancing the brightness the cameras in the array in accordance with the present invention;

FIG. 6 is a schematic diagram of an image matrix cube in accordance with the present invention;

FIG. 7 is a flow diagram of the image segmentation process in accordance with the present invention;

FIG. 8 is a schematic diagram showing the operation of the compression method in accordance with the present invention;

FIG. 9 is a schematic block diagram of a compression encoder in accordance with the present invention;

FIG. 10 is a schematic block diagram of a compression decoder in accordance with the present invention;

FIG. 11 is a schematic diagram of an image file in accordance with the present invention;

FIG. 12 is a screen print out of the GUI of the composer device in accordance with the present invention;

FIG. 13 is a schematic diagram of an image matrix cube in accordance with the present invention;

FIG. 14 is a schematic diagram of the editor device in accordance with the present invention; and

FIG. 15 is a screen print out of the GUI of the viewer device in accordance with the present invention.

### DETAILED DESCRIPTION

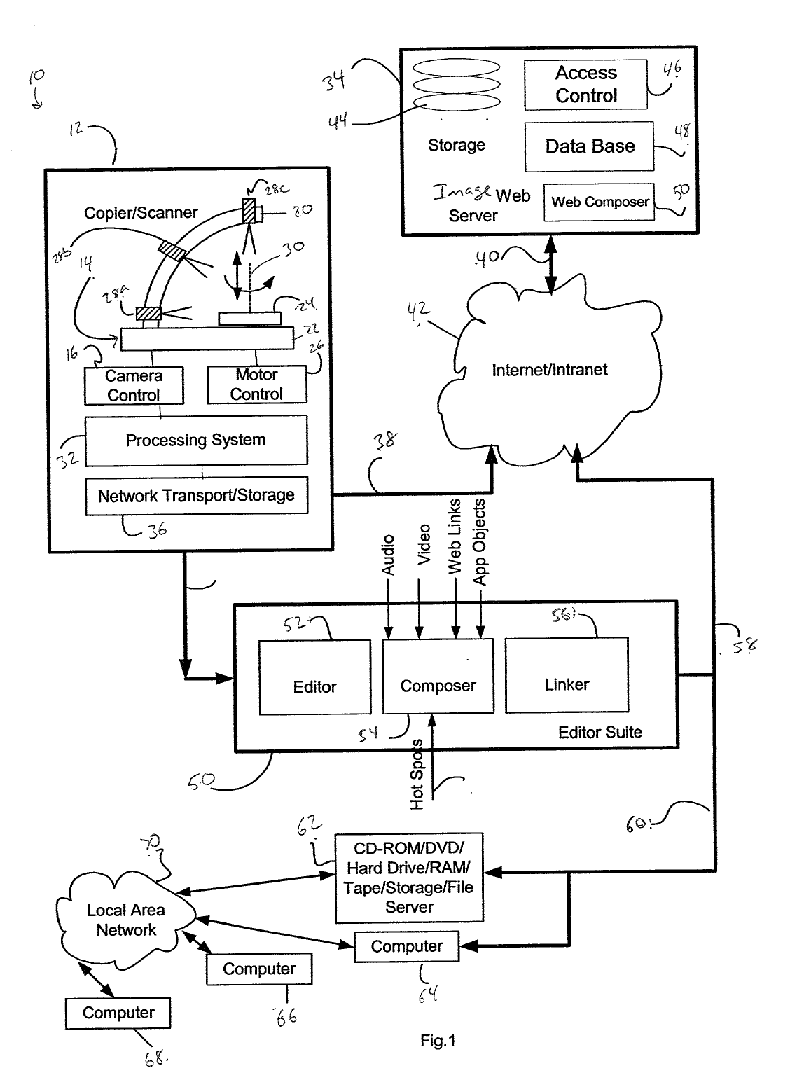

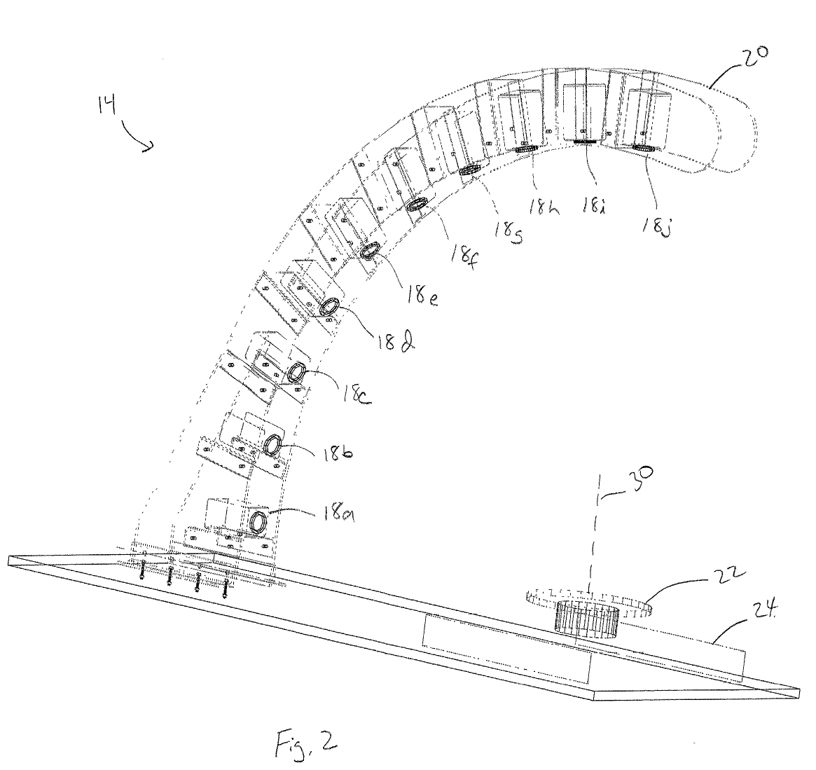

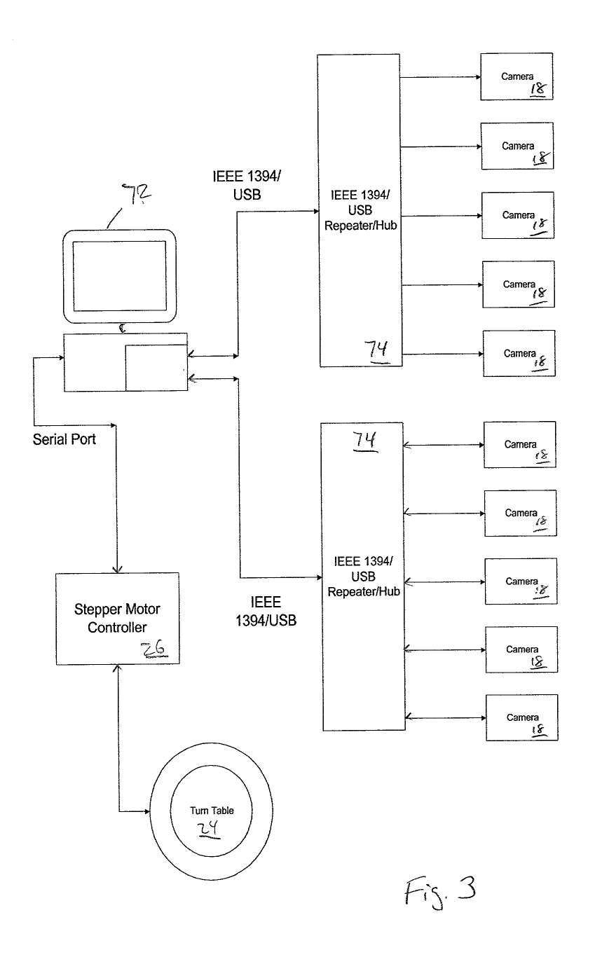

A preferred embodiment of the system for generating and viewing multi-dimensional images according to the present invention is shown at 10 in FIG. 1. A scanner system 12 includes a spherical scanning device 14 for scanning an object placed inside the scanner. The scanning device 14 is an opto-mechanical system precisely controlled by a controller system including a camera control device 16 that controls an array of digital cameras 18, FIG. 2, mounted on a curved arm 20 positioned exactly in the proximity of a stepper motor 22 which powers a controlled turntable 24. Typically, cameras 18 are placed at equidistant intervals along the arm 20, although such an arrangement is not critical to the operation of the invention, as is described below. Furthermore, while in the preferred embodiment, the cameras 18 are mounted in an arc on curved arm 20, the cameras may be configured in any orientation from the turntable 24. The arc configuration, however, reduces the complexities involved in controlling the cameras, as is described below. The turntable 24 supports an object (not shown) placed on it and rotates the object while the array of cameras 18 capture images of the object, as described below. A motor control device 26 controls the turntable motor to precisely position the object to enable the cameras 18 to capture the images of the object without having to move the arm 20. The motor control device 26 also provides facility to lift the turntable 24 up or down such that a small or large object can be positioned for optimal imaging. FIG. 3 is a schematic block diagram showing the configuration of the components that make up the camera and motor control systems 16 and 26. As shown in FIG. 3, cameras 18 are coupled to a computer 72 via repeaters/USB hubs 74 for receiving control instructions and status data from the computer 72. Control of the cameras 18 is described in detail below. Likewise, motor controller 26 is coupled to computer 72 for receiving control instructions and status data therefrom.

Placement of an object on the turntable 24 is critical for creating a smoothly turning image set of the object. To help in this objective, the system 10 includes laser markers 28a, 28b and 28c mounted on the arm 20 to identify the location of the center of rotation of the turn table 24. The laser markers 28a, 28b, 28c are preferably line generators positioned to mark the center of the turn table in three axes. The laser markers move in a scanning pattern by means of a galvanometer arrangement, such that precise position information is obtained. The coordination of the camera control device 16 and the motor control device 26 helps in creating a mosaic of images containing all possible views of the object. The images gathered from the cameras are organized as a main image matrix (MIM). Because the arm 20 is shaped as a quadrant of a circle, when the turn table 24 makes a 360 degree rotation, the cameras sweep a hemisphere positioned at the axis of rotation of the turn table 30.

The scanner system 12 includes processing system 32 which provides support for pre-processing before images are obtained from the cameras 18. It also provides support for post-processing of the collected images from the cameras 18. As is described below, pre-processing helps in setting the parameters of the cameras 18 for high quality image capture. For instance, the cameras have to be adjusted for a sharp focus. Since different cameras look at the object at different angles, they all may have different focus, aperture, shutter, zoom lens parameters. The pre-processing procedure sets correct values for all the camera parameters. The post-processing procedure, also described below, begins after the images are collected from the cameras 18. For optimal operation of the system 10, it is necessary to have uniform illumination of the object before the pictures are taken. The illumination system is not shown in FIG. 1 to avoid clutter. Since any given object can have a highly reflective surface or a highly light absorbing surface, it is not possible to adjust the camera parameters a priori. It is therefore necessary to process the images to correct for background flickers and wobbling that appears due to incorrect positioning of the object. Since the exact size and shape of an object is not known to the system, post processing is necessary. In addition to these processing steps, further processing of the images is needed to remove the back ground in the images (“segmentation”) and align the images for a smooth display. Segmentation is a necessary step for compression of the images. These processing steps carried out by processing system 32 are described in detail below. In addition, post processing can also generate synthetic views from arbitrary locations of non-existing cameras. It can also create geometric measurement of the object. If the laser markers are equipped with galvanometer assisted scanning, the processing can generate accurate 3D models from the input images.

The captured images are either stored locally or transported to image web server 34. Local storage of the captured images takes place on network transport/storage device 36, which also enables the transport of the captured images to the image web server 34 through an ethernet or similar network connection device. The connection between the scanner/copier system 12 and the image web server 34 takes place through data path 38 and data path 40, which are included in a network such as the internet or an intranet shown symbolically at 42. Data paths 38 and 40 may be wired paths or wireless paths. The mechanism by which the image data is transported could be by a “ftp” connection and with a “upload script” running on the scanner/copier 12. In this way, the copying of an object is an automatic process without any need for manual assistance. Once scanning of the object is done and processed, the data can be packed and shipped to the web server 34 for storing into the storage device 44, which may be any type storage medium capable of storing image data in a web server architecture. The web server 34 is typically coupled to high speed backbone access points. From an implementation point of view, the web server 34 could be a software device such as Apache Server® running on a Linux® platform or an “IIS” running on Windows® platform. It also could be a special hardware system optimized for quick access and speed of delivery. Internally, the web server 34 contains the storage device 44 in which main image matrices are stored, an access control system, 46 from which the web server access is monitored and controlled, and a data base system 48, which keeps a data base model of the data storage and facilitates flexible access to the data storage in storage device 44. The database system 48 also permits cataloging, sorting, and searching of the stored data in a convenient manner. The web server 34 also contains a web composer 50, which is similar in operation to the editing device 52, described below, but which is available on the network 42 as a web application. The web composer 50 enables an operator to attach meta-data (described below) to the captured images in a dynamic manner by attaching resources within the web server as well as resources on the network.

The web server 34 accepts requests made by any client computer system over the internet/intranet 42 and delivers the image data with an encapsulated self-executing Java Applet. The Java applet makes it possible to view the image data on any client computer system connected with the network 42.

The image data also can be processed for meta-data insertion and manipulation with the help of the editor suite 50. The editor suite 50 includes an editor device 52, a composer device 54 and a linking device 56, which can be embodied as either software program or a hardware system. Editor suite 50 can be a stand-alone configuration, or it can be configured as a part of the scanner system 12. As described in detail below, editor device 52, which can add or remove image matrices, select camera views and rotational angles, first manipulates the image data. The editor device 52 can also perform image correction operations such as gamma correction and tint correction and operations such as background removal, segmentation and compression. Next, a composer device 54 enables the addition of meta-data such as audio, video, web links, office application objects (“OLE Objects”), and hotspots. As is described below, a hotspot is a piece of information which is linked to a portion of an image that operates to provide further information about the object to the viewer. Hotspots can be embedded in any image that can trigger a presentation of meta-data or a web link connection. The hotspot information can be manually generated or generated automatically by inserting a colored material on the object that acts as a trigger. The output of the composer device 54 is an embedded image matrix with appropriately added meta-data.

Linking device 56 links many such embedded image matrices to create a hierarchy of embedded matrices that describe a product in an orderly manner. In other words, a product can be decomposed as a set of sub-components, which in turn can have sub parts. An embedded matrix can be used to describe a sub part in a lower level of this decomposition. The linking device 56 then assembles all such embedded matrices to create a systematic presentation of the entire product which can be “peeled off” in layers and navigated freely to understand the complex construction of a product. Since such a presentation is powerful tool in different design, manufacturing, troubleshooting, sales operations, the linking device 56 is capable of generating the final data in two different formats. A “low bandwidth” version is transmitted via data path 58 for storage in the web server 34 for web applications, and a “high bandwidth” version is transmitted via data path 60 for storage in local storage systems such as a file server 62 which can be any computer with CDROM/DVD/Tape/Hard drives or any special purpose standalone storage system connected to a network.

The “high bandwidth” version of image data can be viewed on any computer with a high bandwidth viewer application. Hence any computer such as 64, 66 and 68 connected to file server 62 over local area network 70 can view the complete presentation of a product easily and effectively. A low bandwidth viewer applet is made available by the web server 34 when a client machine (not shown) makes a request via network 42.

Prior to the scanning operation of an object to create the main image matrix, a preprocessing function must be carried out to insure that the images captured by each of the cameras 18 are of sufficient quality that the post processing steps, described below, can be carried out. When an object is placed in front of the cameras 18 on the turntable 24, it is necessary to focus the cameras 18 on the object so that the pictures taken by the camera are in sharp focus. This has to be done for every camera. Since the cameras are placed in an arc, the adjustments done for a single camera can be taken as initial settings for other cameras, as all the cameras hold roughly the same distance to the object. However, since the object can have different shapes with respect to individual cameras, the measurements made for the first camera may not hold for the others. Therefore, even if the cameras are placed in an arc, such as is shown in FIGS. 1 and 2, the focus adjustments done for the first camera must be taken only as a starting value. If there is no structure in the placement of cameras, then focus measurements must be done individually for every camera.

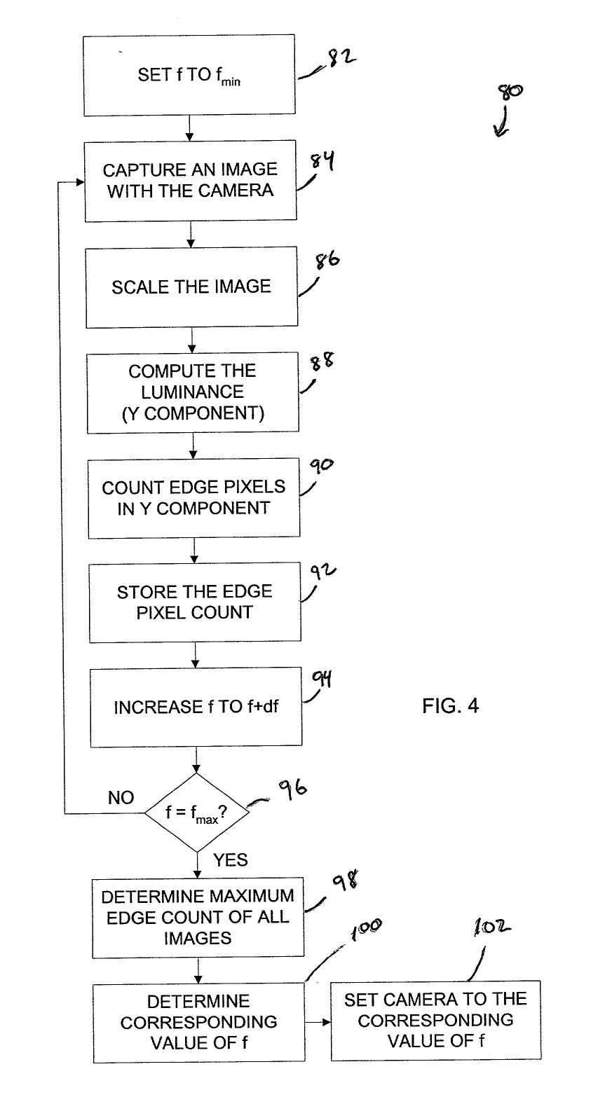

FIG. 4 shows a flow diagram 80 of the auto-focus procedure carried out in software by the computer 72 in order to set each camera at the ideal focus setting f. In step 82 the focus setting f of the camera being focused is set to its minimum value, fₘᵢₙ. An image of the object is captured with the camera, step 84, and the image is scaled to a smaller size by decimating pixels in the vertical and horizontal dimensions. In step 88, the luminance or Y component of the scaled image is determined and the number of either vertical or horizontal edge pixels in the Y component of the image is measured, step 90. In this step, while either the vertical or horizontal edge pixels may be counted in the first image, the same edge must be counted in successive images as was counted in the first image. This edge pixel count is stored in memory and the focus setting f is increased by an increment df, step 94. This increment can vary depending on the clarity needed for producing the image sets. For example, if the object is very detailed or includes intricate components, the increment df may be smaller than in the case where the object is not very detailed. In step 96, the system determines if the new focus setting is the maximum setting for the camera, fₘₐₓ. If it is not, the process returns to step 84 and a second image is captured by the cameras. The image is scaled, step 86, the Y component is determined, step 88 and the Y component edge pixels are counted and stored, steps 92 and 94. Once it is determined in step 96 that the camera's focus setting has reached fₘₐₓ, the maximum edge pixel count for all of the images is determined, step 98. The image having the greatest number of edge pixels is considered to be the most focused image. The focus setting f that corresponds to the image having the greatest number of edge pixels is determined, step 100, and the camera is set to this focus setting, step 102.

The next preprocessing step involves balancing the brightness between the cameras 18 in the array. When an object is placed for picture taking, adequate illumination must be available on the surface of the object. Making sure that diffuse and uniform lighting exists around the object can help in achieving this goal. However, each camera “looks” at the object at a different angle and hence light gathered by the lens of each camera can be quite different. As a result, each picture from a different camera can have different brightness. When such a set of pictures are used to view the object, then there could be significant flicker between the pictures.

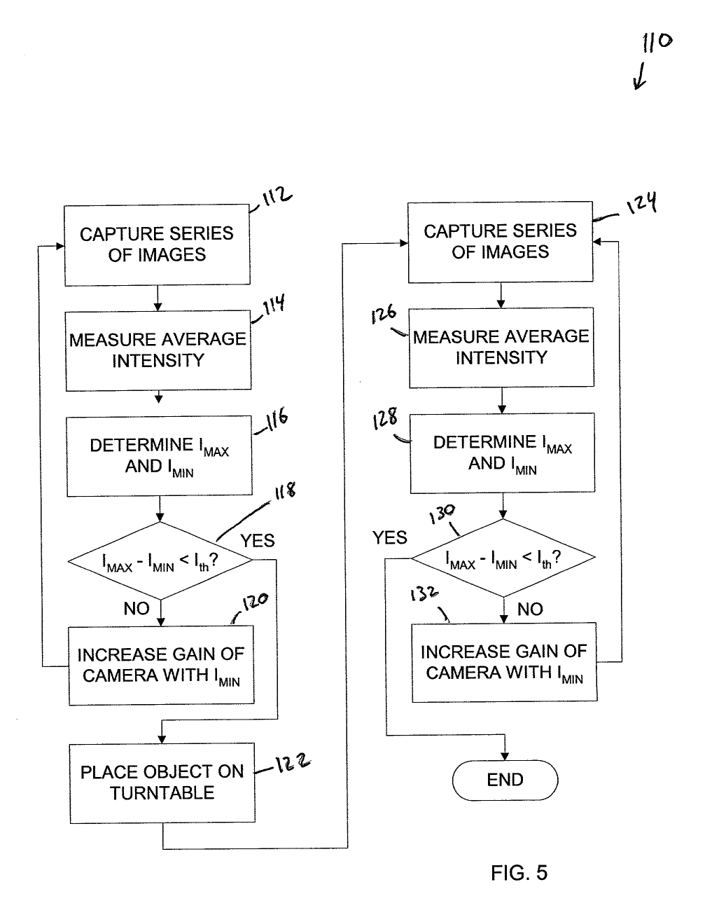

FIG. 5 shows a flow diagram 110 of the brightness balancing procedure carried out in software by the computer 72 in order to set the gain of each camera at a setting such that the brightness of images captured by the array of cameras 18 are within a threshold value. In step 112, a series of images is captured, in which each camera in the array captures an image of the turntable and background area with no object present. In step 114, the average intensity of each image is determined according to the following equation:

Average Intensity=0.33Σ_{x,y}(R_{(x,y)}+G_{(x,y)}+B_{(x,y)})

where: R_{(x,y)} is the red color value of pixel (x,y)

G_{(x,y)} is the green color value of pixel (x,y); and

B_{(x,y)} is the blue color value of pixel (x,y).

The images having the maximum average intensity I_{MAX} and the minimum average intensity I_{MIN} are then identified, step 116. If the difference between the maximum average intensity I_{MAX} and the minimum average intensity I_{MIN} is greater than a predetermined intensity threshold, step 118, the gain of the camera that produced the image having the minimum average intensity I_{MIN} is increased by a small increment, step 120, and the process returns to step 112. This loop of the procedure insures that the intensity output of each camera is balanced with respect to the other cameras. Once the intensity is balanced, meaning that the intensity of each cameras is within a certain threshold range, the object is placed on the turntable, step 122, and the steps of the loop are repeated. Specifically, in step 124, a series of images including the object is captured by the array of cameras, and the average intensity of each of the images is measured, step 126. The maximum average intensity Iₘₐₓ and the minimum average intensity I_{MIN} of the images are determined, step 128, and, if the difference between the maximum average intensity I_{MAX} and the minimum average intensity I_{MIN} is greater than a predetermined intensity threshold, step 130, the gain of the camera that produced the image having the minimum average intensity I_{MIN} is increased by a small increment, step 132, and the process returns to step 124. This loop is repeated until the difference between the maximum average intensity Iₘₐₓ and the minimum average intensity I_{MIN} of the images is less than the predetermined intensity threshold, meaning that the intensity of the images captured by the cameras in the array fall within the threshold range.

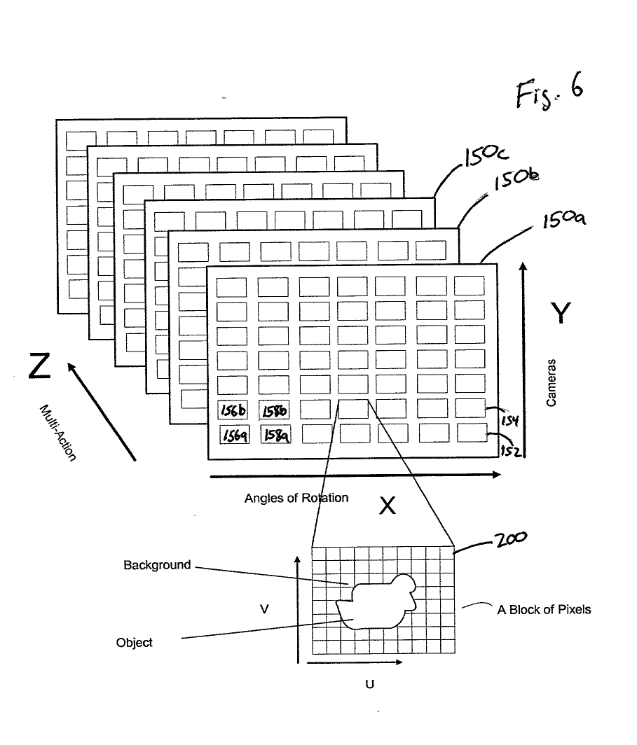

Once the preprocessing steps have been carried out, the scanner system 12 carries out the image capturing procedure. This involves each of the cameras capturing an image of the object at each of a number of rotation angles of the object to form a two dimensional image matrix 150, as shown in FIG. 6. Conceptually, the X direction is associated with the turntable movement. In a full scan, the turntable completes a 360-degree rotation. If the turntable is programmed to turn only α degrees each time before images are captured then there will be

$$\frac{360}{α} = X$$

different images. If there are Y cameras in the system, then there will be (X·Y) images resulting from a full scan. As shown in FIG. 6, plane 150a includes a number of images, shown as empty boxes for simplicity. For further simplicity, the preferred complete matrix of 360 images (10 cameras at 36 angles of rotation) is not shown. Row 152 of matrix 150a includes the images taken by the first camera 18 in the array at each of the angles of rotation, row 154 of matrix 150a includes the images taken by the second camera 18 in the array at each of the angles of rotation, etc. Accordingly, image 156a is an image taken by the first camera 18 of the array at the first angle of rotation and image 156b is an image taken by the second camera 18 at the first angle of rotation. Likewise, image 158a is an image taken by the first camera 18 of the array at the second angle of rotation and image 158b is an image taken by the second camera 18 at the second angle of rotation. The remaining images form the matrix including images from each camera of the array at each of the angles of rotation.

An example of an image matrix is shown at 700 in FIG. 16. Image matrix 700 shows multiple images of a power drill placed on turntable 24, FIG. 2. For simplicity, only a 5×5 matrix, corresponding to five different cameras capturing images at five different angles of rotation, is shown in this example. It will be understood that any number of cameras may be used to capture images at any number of angles of rotation. In this example, row 702a of matrix 700 includes images captured by camera 18a, FIG. 2; row 702b includes images captured by camera 18c; row 702c includes images captured by camera 18e; row 702d includes images captured by camera 18h; and row 702e includes images captured by camera 18j. Likewise, column 704a includes images captured at 0°; column 704b includes images captured at approximately 80°; column 704c includes images captured at approximately 160°; column 704d includes images captured at approximately 240°; and column 704e includes images captured at approximately 320°. Accordingly, it can be seen that image 710 is an image captured by camera 18e at 80° of rotation; image 712 is an image captured by camera 18h at 160° of rotation; image 714 is an image captured by camera 18j at 320° of rotation, etc. As is described below, the architecture of this matrix enables a viewer to view the object from any one of a number of viewing angles.

In addition to images taken by the multiple cameras over multiple rotation angles to form a single matrix 150a, multiple matrices may be formed. Matrix 150b, for example, may be formed by zooming each camera 18 into the object to obtain a closer perspective and having each camera capture an image at each of the rotation angles. Matrix 150c, for example, may be formed by manipulating the object to a different position, such as by opening a door of the object. Each camera then captures an image of the object at each of the rotation angles to form matrix 150c. This type of matrix is referred to as a “multi-action” matrix. This forms a 3-D stack of images including the 2-D planes 150 which form the Z-axis of the cube. Accordingly, a total of (X·Y·Z) images form each cube.

At the completion of the image-capturing process, post-processing of the images is performed. Post-processing involves robust identification of the object in each image and image segmentation. This post processing prepares the images for further editing and compilation as is described below. First, the object in each image must be robustly identified to differentiate between the foreground pixels that make up the object and the background pixels. In addition to the image capturing process described above, a matrix of images are taken by each camera at each angle of rotation with the object removed from the turntable. By processing the pair of images taken by each camera at each angle of rotation—one with just background and another with object and background—robust identification of the object can be made. The method for robust identification includes the following steps:

1. Divide the pair of corresponding images into a number of square blocks;

2. Measure the distance and correlation between corresponding blocks;

3. Place a statistical threshold for object detection;

4. Fill holes and remove isolated noisy blocks detected as the object;

5. Find a smooth bezier curve encircling the object;

6. Remove the background part; and

7. Blend in the detected object in a white background.

Once the object in an image has been identified, it undergoes an image segmentation and three-dimensional reconstruction process. This process is used to estimate three-dimensional geometries of objects being scanned. This three-dimensional information allows not only for an enhanced visual display capability, but it also facilitates higher compression ratios for the image files, as is described below. Furthermore, it makes it possible to alter the background field of the scanned object. For example, it is possible to separate the foreground object from the background and modify the background with a different color or texture, while leaving the foreground object intact. The imaging system of the present invention relies only on the acquired digital camera images (i.e., software only). The crucial component in providing the three-dimensional estimation capabilities is the robust image segmentation method described below. This method provides the end user with a fully automated solution for separating foreground and background objects, reconstructing a three-dimensional object representation, and incorporating this information into the image output. The combination of image segmentation using active contour models and three-dimensional reconstruction algorithms with the scanner data provides a unique imaging and measurement system.

This portion of the invention provides a method for automatically segmenting foreground objects from a sequence of spatially correlated digital images. This method is computationally efficient (in terms of computational time and memory), robust, and general purpose.

Furthermore, this method can also generate as an output, an estimation of the 3D bounding shape of the segmented object.

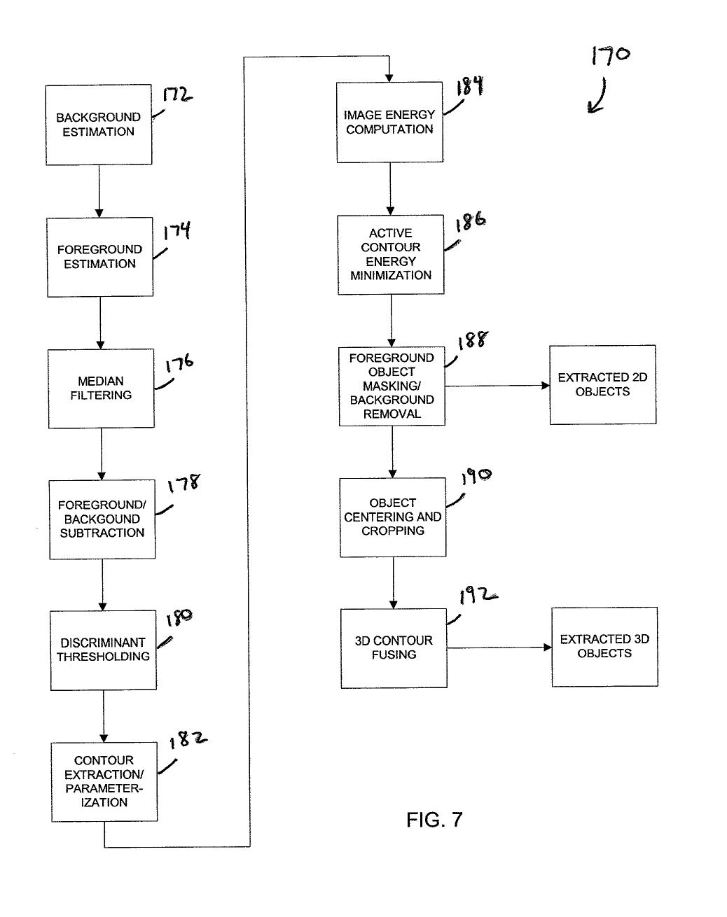

The methodology used to perform segmentation and three-dimensional reconstruction is described below. This multi-stage image pipeline converts a stream of spatially-correlated digital images into a set of two- and three-dimensional objects. The steps of the pipeline, shown in flow diagram 170 of FIG. 7, are as follows:

Background estimation

Foreground estimation

Median Filtering

Background/Foreground subtraction

Discriminant thresholding

Contour extraction/parameterization

Image energy computation

Active contour energy minimization

Foreground object masking and background removal

Object centering and cropping

3D Contour fusing

Each of the steps are described in more detail below.

Background estimation and sampling

In step 172, a first-order estimate is made of the mean and variance of the RGB background pixel values based on a peripheral region-weighting sampling method. The result of this sample is used to estimate an a priori discriminant function using the median and variance of an N×N neighborhood surrounding each image pixel along a peripheral function. In the preferred embodiment of the invention, a 3×3 neighborhood is utilized. The definition of the peripheral region-weighting function is defined by the line integral of the two-dimensional hyper-quadric function:

(xⁿ)/(αC²)+(yⁿ)/(αR¹)=1 Eqn. 1

where,

C=image width in pixels (columns)

R=image height in pixels (rows)

and optimal values for n and α have been determined to be:

α=0.9; and

The median of the line integral, ml, is defined as the median intensity value of all the pixels along the line integral (Eqn. 1). The median standard deviation, s₁, is defined as the median of the standard deviation of each of the N×N neighborhoods along the line integral define by Eqn. 1.

Foreground estimation

In step 174, the foreground can be estimated by computing the mean and standard deviation at each image pixel using a N×N square neighborhood and comparing these values with the background estimator. The foreground estimation function consists of two distinct components, ΔI₁ and ΔI₂:

ΔI₁=∇_{κ}{varₙ(Iᵣ)+varₙ(I_{g})+varₙ(I_{b})+varₙ(I_{r-g})+varₙ(I_{r-b})+varₙ(I_{g-b})} Eqn. 2

where

∇_{κ} is a 3×3 sharpness filter which sharpness factor defined by κ, (κ=1 [symbol] minimal sharpness, κ=9 [symbol] maximal sharpness);

Iᵣ, I_{g}, I_{b} are the red, green, and blue image components respectively;

I_{r-g}, I_{r-b}, I_{g-b} are the pairwise differential red, green, blue components, respectively;

varₙ(I) is the image variance filter computed using an N×N neighborhood at each pixel;

and,

ΔI₂=varₙ(Iₘ); Eqn. 3

where

Iₘ=is the monochrome value of the RGB input image (i.e., grayscale value).

Median filtering

Median filtering, step 176, is an essential step that closes gaps in the output of the discriminant thresholded image. This yields a more robust boundary initialization for the subsequent active contour model segmentation. Since median filtering is a process which is known in the art, it will not be described herein.

Background/Foreground subtraction

The estimation of background and foreground objects can be improved by acquiring images of the object scene with the foreground object removed. The yields a background-only image that can be subtracted, step 178, from the image having both the background and foreground to yield a difference image which improves the accuracy of the discriminant function. The subtraction is performed on the RGB vector values of each pair of corresponding pixels in the background-only image and the background-and-foreground image.

Discriminant thresholding

In step 180, a multi-dimensional discriminant combines the background estimation with the difference image to yield a more accurate estimation of the true foreground object. The default discriminant function has been tested to yield optimal results with a wide range of objects:

D(I)=ΔI₁>7γ₁|ΔI₂>100γ₂ Eqn. 4

where,

γ_{1,2}=threshold value, within nominal range [0.8 2.0]; and the nominal value is 1.2.

The values of γ_{1,2} can be made adaptive to yield even better results for the discriminant function under specific conditions. Accordingly, the output of the discriminant filter is binarized to yield the final foreground object mask.

Contour extraction and parameterization

The result of the binarization step contains many spurious islands of false positives that must be removed from the foreground object. This is accomplished by extracting the contours of each positive pixel group and sorting these contours based on their perimeter lengths, step 182. Contours with perimeter lengths below a threshold value are pruned from the foreground mask. Any spurious outlying contours can be rejected by inspecting centroid values. Alternatively, if only one dominant object is desired, the contour with the longest perimeter is selected. The selected contours are used as the initial values for the active contour model.

Image energy computation

An image energy function, Fₑ is computed, step 184, which contains minimums at all the edges of the original input image. The first step in computing Fₑ is to extract the dominant edges from input image. This can be accomplished by using the Canny edge detector. The Canny edge detector will generate a binary image with non-zero pixel values along the dominant edges. More importantly, the Canny edge detector will have non-maximal edges suppressed, yielding edges with a unit thickness. This binary edge image is then convolved with a gaussian kernel to provide a smooth and continuous energy field function. In the preferred embodiment, the binary edge image is convolved seven times with a 9×9 gaussian kernel. This function is then masked with the binary discriminant mask function (Eqn. 4). Finally, the function is normalized between 0 and 255 and is suitable for minimization by the active contour.

Active contour optimization

In step 186, the active contour is initialized using the binary foreground object mask from Eqn. 4. The contour points are taken from all the pixel locations along the perimeter of the object mask. The total energy, Et, is similar to the original Kass and Witkin formulation [Kass87: Kass, M., Witkin, A. and Terzopoulos, D. “Snake: Active Contour Models”, International Journal of Computer Vision, Kluwer Academic Publishers, 1(4): 321-331, 1987] but only contains the field energy, Fₑ, described previously, and the internal energy of the contour, Iₑ:

Eₜ=Fₑ+Iₑ Eqn. 5

where,

Iₑ=∫_{Ω}α|∂s(u)/∂u|²du+∫_{Ω}β|∂²s(u)/∂u²|du; and Eqn. 6

s(u) is the contour parameterized by the closed interval Ω: [0 1].

The total energy, Eₜ, is then minimized to extract a more precise boundary of the foreground object using the following implicit minimization function:

φ(Eₜ, s)=−α{Eₜ(sᵢ₊₁)+Eₜ(sᵢ)}−α{sᵢ−(sᵢ₋₁+sᵢ₊₁)/2}−β/2(sᵢ+sᵢ) Eqn. 6b

where,

sᵢ is the (x,y) coordinate of the contour at the i^{th} contour point

Eₜ(sᵢ) is the total energy at the contour point sᵢ

This minimization function φ has the property that it yields very fast convergence times and at the same time yields a stable solution. This function converges in a fraction of a second for similar sized images and achieve satisfactory results in a deterministic time frame. This makes the function highly suitable for real-time or near real-time segmentation applications. The minimization function is also very robust in the sense that it will always yield a well-defined boundary under all input conditions. This is achieved by using an implicit downhill gradient search method in which the active contour points move with an isokinetic constraint (i.e., constant velocity). At each time step, each contour point moves in the direction of the downhill gradient with a fixed As displacement. Hence,

∂²s(t)/∂t²=0.

The unit step vector for each contour point is computed as:

Δₙ=−{∇Fₑ+α[xₙ−(xₙ₋₁+xₙ₊₁)/2]+β(xₙ−xₙ₋₁)}/∥∇Fₑ+α[xₙ−(xₙ₋₁+xₙ₊₁)/2]+β(xₙ−xₙ₋₁)∥ Eqn. 7

for all n in [1 . . . N], where N=number of contour points

However, this step vector can be computed much more quickly using the following approximation:

Δsₙ=−Min{Max{−1,{1,∇Fₑ+Δ[xₙ−(xₙ₋₁+xₙ₊₁)/2]+β(xₙ−xₙ₋₁)} } Eqn. 8

This approximation, in combination with the downhill gradient minimization strategy, results in a fast, yet robust solution to the minimization of Eₜ.

Foreground object masking and background removal

In step 188, the optimized active contour is converted back to a binary image mask which is then used to extract the foreground object from the original image. The image mask may be created by using a seed growing algorithm with the initial seed set outside the contour boundary. All pixels outside the contour are filled, leaving an unfilled region corresponding to the object itself. The original image can be sharpened or filtered before the masking step if desired. The result is an image which contains only the filtered foreground object.

Object Centering and Cropping

One of the difficulties in creating image matrices from a spherical camera array is that individual camera positions and orientations are subject to mechanical deviations. As a result, the object may appear to jump in an apparently random fashion between adjacent images. In step 190, an object extraction function is used to correct for these mechanical deviations by computing the centroid of each object contour in each image. The centroid is computed as follows:

X_{c}=1/N[Σ_{N}xₙ, Σ_{N}yₙ]; Eqn. 9

where N is the total number of contour points.

After the centroid is computed, a bounding box for the object in each image is computed by searching for the maximum and minimum values of xₙ and yₙ. By amalgamating the centroids and the bounding boxes across all images, a master bounding box of all the bounding boxes is computed, and the objects are displaced so that each centroid is at the center of the master bounding box.

3D contour fusing

The extracted contours from each image are scaled according to the camera-based calibration or scale factors (αₓₖ, α_{yk}, α_{zk}) to account for inhomogenities among the set of k cameras in the array. Since the object is rotated along the X-axis, the scaled contours are rotated first along the x-axis and then along the z-axis. θₓₖ is the azimuth angle (latitude) of the k-th camera and θ_{zn} is the n-th angle of the rotation of the platter (longitude):

$${S}_{kn}^{′} = [ \begin{matrix}{α}_{xk} & 0 & 0 & 0 \\ 0 & {α}_{yk} & 0 & 0 \\ 0 & 0 & {α}_{zk} & 0 \\ 0 & 0 & 0 & 1\end{matrix} ] [ \begin{matrix}1 & 0 & 0 & 0 \\ 0 & cos {θ}_{xk} & sin {θ}_{xk} & 0 \\ 0 & - sin {θ}_{xk} & cos {θ}_{kx} & 0 \\ 0 & 0 & 0 & 1\end{matrix} ] [ \begin{matrix}cos {θ}_{nz} & - sin {θ}_{zn} & 0 & 0 \\ sin {θ}_{zn} & cos {θ}_{zn} & 0 & 0 \\ 0 & 0 & 1 & 0 \\ 0 & 0 & 0 & 1\end{matrix} ] {S}_{kn}$$

where,

Sₖₙ is the contour associated with the k-th camera and n-th rotation.

The transformed contours are then merged to yield a three-dimensional surface model estimate of the foreground object. This three-dimensional surface model can now be viewed and manipulated in a standard CAD program.

After the object is identified and segmented in each image according to the method described above, all the images containing the segmented object must be aligned and centered. Though the vertical camera plane coincides with the rotational axis of the turntable, it is not always possible place the object on the turntable exactly at its center of gravity. Also when a multi-action capture is done and the object is taken out to remove or move a part, it is not always possible to place the object exactly at the same point. Because of these factors, digital alignment of images must be done.

The alignment function includes the following steps:

1. Segment and detect the object

2. Find the bounding box of the object

3. Repeat the above for all input images

4. Find the biggest size of the bounding box that will hold all segmented objects

5. Within this big box place the objects so that they all are aligned and centered.

In order to be able to efficiently transmit the captured images from the web server to a computer over a network, it is important to reduce the amount of data transmitted. The reduction in data is accomplished by compression of the image data. As set forth above, FIG. 6 shows the image matrix as a three dimensional data cube where the X axis corresponds to the number of angles of rotation of the turntable, Y axis shows the number of cameras used for capture, and the Z axis represents the number of multi-action captures. Hence, if y cameras are used with x number of angles of rotation and if there are z multi-actions in the capture, then the total number of images in the data cube are equal to xyz. Each of these images, assumed to be equal in horizontal and vertical pixel resolution, are divided into U×V image blocks 200. All the encoding operations are performed on these image blocks 200.

As explained in the previous sections, each image is segmented, i.e., divided into a background part and a foreground object part. This binary segmentation helps in reducing the number of pixels operated upon. It is only necessary to encode the region where the object exists, as the background is irrelevant and can be synthetically regenerated at the receiver end. The shape of the object can be explicitly encoded as shape information or can be encoded implicitly. In the following we assume shape encoding is done implicitly and a special code is used to convey the background information to the receiver.

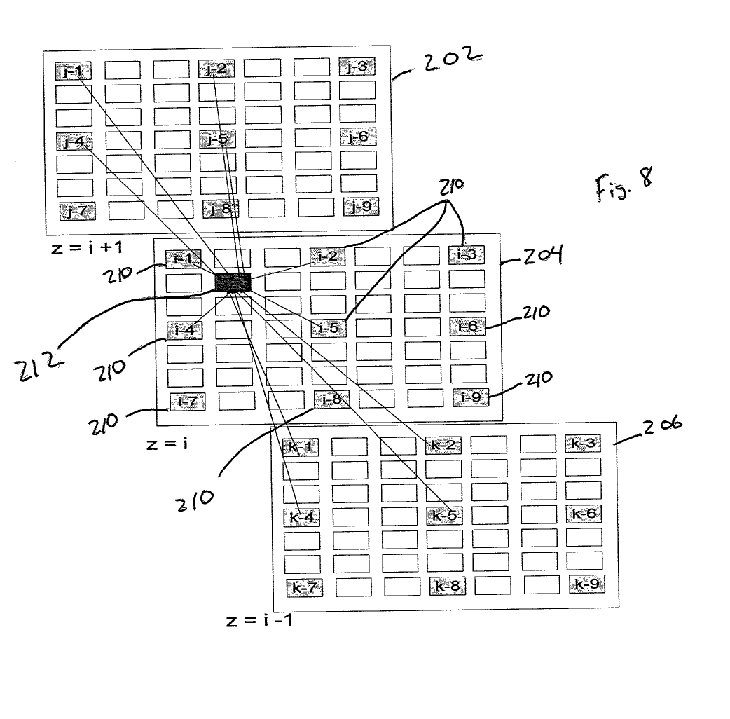

The basic principle of compression is to use a small set of image blocks as references and attempt to derive other image blocks from these reference image blocks. For the sake of clarity in this description, these reference images are referred to as “I frames” to denote “intra frames”. The number of I frames determine the compression efficiency and the quality of decoded images in the image data cube. I frames are distributed evenly in the data cube. The rest of the image blocks are predicted from these I frames. FIG. 8 shows three consecutive corresponding images in the Z-direction or in the “multi-action” planes, i+1 (202); i (204); and i−1 (206), in consecutive matrices. The I frames are shaded and indicated by reference numeral 210 in image 204. Corresponding I frames are shown in images 202 and 206, but are not labeled for simplicity.

FIG. 8 shows a situation where the image block shown at 212 is predicted by image blocks in its vicinity. Because of the way the data cube is constructed, there exists very strong correlation between image blocks in the same multi-action plane, i.e., for the multi-action plane z=i (image 204), the I frames i−1, i−₂, i−₄, i−₅ are strongly correlated with the predicted image shown in image block 212. Since multi-action planes in the data cube also exhibits strong correlation, the image block 212 can also be predicted by adjacent I frames j−1, j−2, j−4, j−5, in the plane z=i+1 (image 202) and adjacent I-frames k−1, k−2, k−4, and k−5 in the plane z=i−1 (image 206). This type of multi-linear prediction allows high degree of redundancy reduction. This type of prediction is referred to as a multi-dimensional prediction or a multi-frame prediction. Though image blocks are correlated as shown in FIG. 8, the prediction error can be minimized by taking into account of disparity or shift within a pair of images. The shift between two image blocks can be estimated by the use of various motion vector estimation algorithms such as minimum absolute difference (MAD) algorithm used, for example, in MPEG standards. This means that each prediction is associated with a motion or shift vector that gives rise to minimum prediction error. Typically, such prediction is done for each image block in an image.

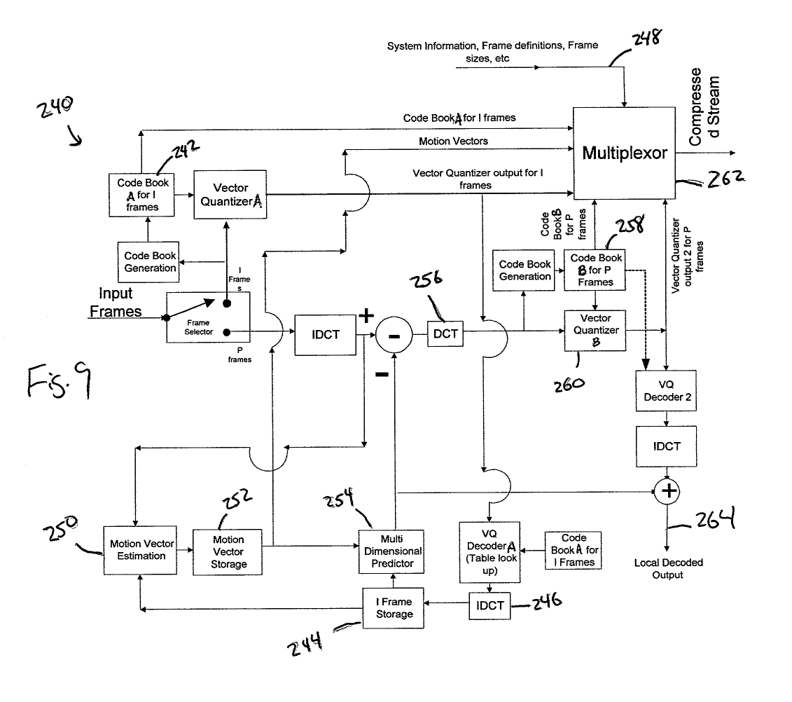

FIG. 9 is a schematic block diagram of a compression encoder system 240. The segmented input frames are first separated into Y, Cr, Cb components after suitable filtering and subsampling to obtain a 4:2:2 format. Then each of the images is divided into image blocks. Each image block is transformed by a 2-D Discrete Cosine Transform (DCT) and quantized to form a high bit rate, high quality, first level encoding. The encoding is done in 4 steps.

Step 1: The image blocks from I frames are first sent to the encoder 240 to generate a high bit rate Vector Quantizer codebook. This code book A 242 can be generated by using Simulated Annealing approach or any other version of Generalized Lloyd's Algorithm. At the completion of the code book A 242 generation, all the image blocks of I frames are encoded using the code book A 242. The encoded blocks are decoded and assembled at the I frame storage 244 after performing inverse DCT at block 246. Now the I Frame storage 244 contains all the I frames in the pixel domain.

Step 2: Next, all relevant system information such as the ratio of I frames to total number of images, their distribution, frame sizes, frame definitions, etc. are sent to the encoder 240 via line 248 so that appropriate I frames can be selected when the predicted images are entered into the encoder 240. The predicted image blocks, referred to as “P-frames”, are first transformed back into pixel domain and motion vector estimation, block 250, from which each predicted block is computed. A corresponding optimum multi-dimensional motion vector is stored in the motion vector storage 252.

Step 3: The predicted image blocks again are entered into encoder 240. For each block, an optimum multi-dimensional motion vector is used to make a multi-dimensional prediction, block 254 from the stored I frames that are closest to the predicted frame. The input block in pixel domain is compared with the prediction and the error in prediction is computed. This prediction error is then transformed into DCT domain, block 256, and is used to generate the error code book B 258 for the vector quantizer B 260.

Step 4: In this final pass, the predicted image blocks are once again entered, and motion prediction error is computed as before in step 3. Now the vector quantizer B, whose output is now input to multiplexor 262 with all other encoded data, quantizes the prediction error. The multiplexor 262 outputs the compressed data stream. Adding the prediction with the vector quantizer B output can create a local decoded output 264. This local decoded output can be monitored to guarantee high quality reproduction at the decoder.

This encoding scheme is an iterative encoding system where reconstruction quality can be finely monitored and tuned. If need be, an additional error coding stage can also be introduced by comparing the local decoded output 264 and the input frame.

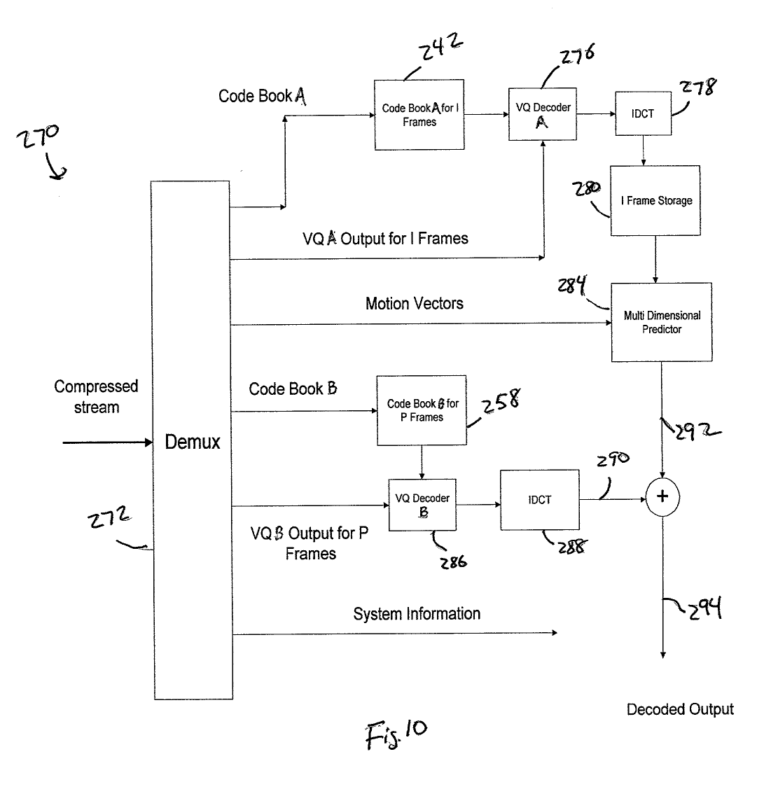

A schematic block diagram of the corresponding decoder system 270 is shown in FIG. 10. The operation of the decoder 270 is the reverse of the operation performed within the encoder 240. The compressed stream is first demultiplexed in demultiplexor 272 to obtain the entries of the code book A 242 which can be used to decode the vector quantizer 276 output. After performing inverse DCT, block 278, I frames are stored into an I frame storage 280. Next, code book B entries are obtained to populate code book B 258. Motion vectors are then demultiplexed to create multi-dimensional prediction of a P frame in block 284. Then vector quantizer B 286 output is decoded and inverse DCT is applied in block 288. When the resulting output 290 is added with the prediction output 292, the decoded output 294 is computed. Because of the table look up advantage of the vector quantizers, decoder complexity is minimized. The only complexity is that of the motion compensated multi-dimensional predictor.

The data that comprises the images must be stored in such a way as to facilitate efficient and effective editing and viewing of the images. In the preferred embodiment of the invention, the data is contained in a type of file referred to as a “.hlg” file. At the fundamental level, there are two types of data contained in a “.hlg” file: (1) data relating to the Main Image Matrices (MIMs) which is the core of the system's “object-centered imaging” approach; and (2) auxiliary data, or meta-data, as set forth above, that enhances the presentation of MIMs. A “.hlg” file is similar to a Product Data Management Vault, in which a product may contain several components, with each component consisting of several subassemblies. Each subassembly may in turn hold several other sub-components.

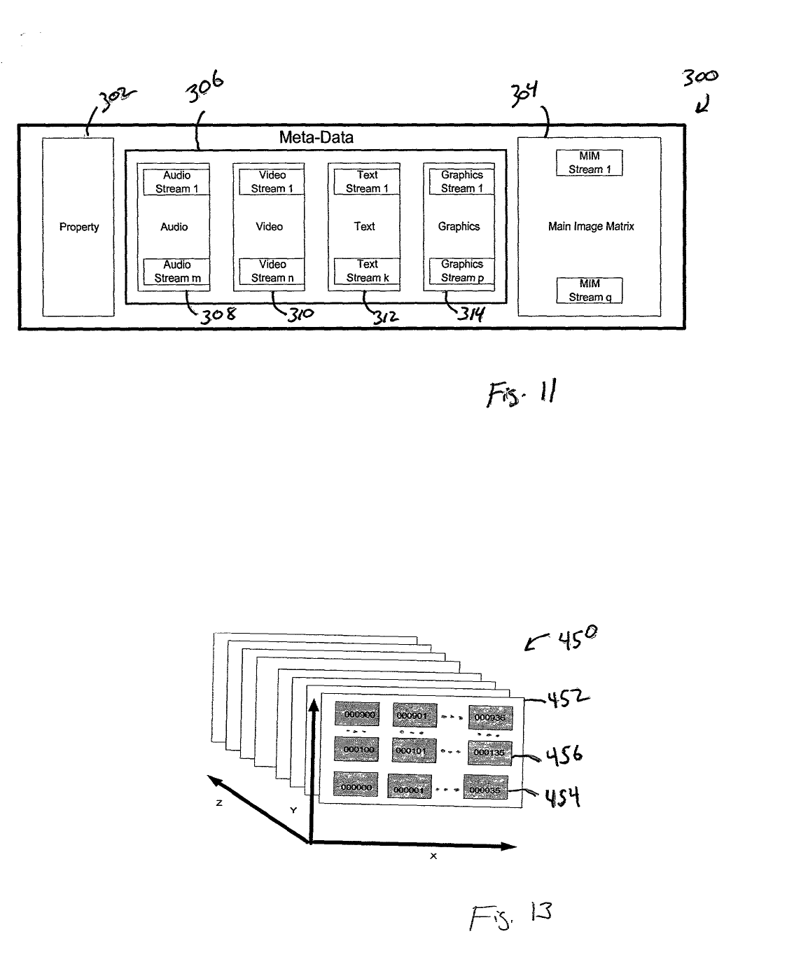

Inter-relationships between different components of a product can be described as a tree diagram. Each branch and leaf can be denoted as a number called hierarchy code. Each MIM then can be associated with a hierarchy code that tells its level in the product hierarchy. Similarly, each meta-data can be associated with a hierarchy code. It is helpful to think of a “.hlg” file as a “file system”. However a “.hlg” is a single file that acts like a file system. It contains all relevant presentation data of a product in a concise and compact manner. It can be shipped across a network such as the internet or can be viewed locally on a CDROM. A “.hlg” file can be viewed as a storage container of image data. Such a “.hlg” file is shown schematically at 300 in FIG. 11.

File 300 includes a property portion 302, a main image matrix (MIM) portion 304 and a meta-data portion 306, which includes an audio subportion 308, a video subportion 310, a text subportion 312 and a graphics subportion 314. Property portion 302 is simply a header that contains all pertinent information regarding the data streams contained. It also contains quick access points to the various streams that are contained in the file. The meta-data portion 306 consists of auxiliary streams while the MIM portion 304 contains the core image data. Each of the subportions 308-314 of meta-data portion 306 and MIM portion 304 include a multitude of data streams contained in a single file. As shown in FIG. 11, there are m different audio streams, n different video streams, k different text streams, p different graphics streams, and q different MIM streams. The integers m, n, k, p, and q are arbitrary, but are typically less than 65536.

The “.hlg” file is an active response file that reacts differently to different user inputs. The state transitions are coded and contained in the file. State transitions are defined for every image in the MIM and hence it is not necessary that every user will view the same sequence of multimedia presentation. Depending the user input, the actual presentation will vary for different instances. Furthermore, the file 300 indirectly defines the actual presentation material in a structured way by combining different multimedia material in a single container file. The file also defines a viewer system that makes the actual presentation and an editor system that constructs the file from component streams.

Each “.hlg” data file contains the following information:

File Generation information;

Access points for different data chunks;

Data stream pertaining to meta-data: Audio, Video, Text, Graphics;

Data stream lengths of all meta-data;

Data stream pertaining to Main Image Matrix: coded image data;

Data stream lengths for Main Image Matrix;

Data chunks pertaining to image hotspot definitions;

Data chunks pertaining to image hotspot triggered control actions; and

Reading and writing procedures that provide fast access.

Meta-data is any type of data that can contribute to or explain the main image matrix (MIM) data in a bigger context. Meta-data could be text, audio, video or graphic files. Meta-data can be classified in two groups, as external meta-data and internal meta-data.

| | External Meta-Data (Auxiliary |
|---|---|
| Internal Meta-Data (Relating to MIM) | information) |
| Hot spots | Audio |
| Object Contours | Video |
| Hot spot contour masks | Graphics |
| Hot spot triggers | Images |
| | Text |
| | Tool tips |
| | Pop-up help windows |

The internal meta-data refers to details such as shape, hotspots (described below), hotspot triggered actions etc., relating to the individual images contained in the MIM. Usually no additional reference, (i.e., indirect reference of a data as a link or a pointer) is needed to access the internal meta-data. On the other hand, external meta-data refers to audio, video, text and graphics information that are not part of the image information contained in the image matrix. The design also allows flexible mixture of internal and external meta-data types.

Specifically, the internal meta-data pertains to higher level descriptions of a single image matrix. For instance, a part of an object shown by the image matrix can be associated with an action. The silhouette or contour of the part can be highlighted to indicate the dynamic action triggered by clicking the mouse on the part.

Each image in the MIM can have a plurality of “hot spots”. Hot spots are preferably rectangular regions specified by four corner pixels. An irregular hot spot can be defined by including a mask image over the rectangular hot spot region. It is the function of the viewer to include and interpret the irregular regions of hot spots.

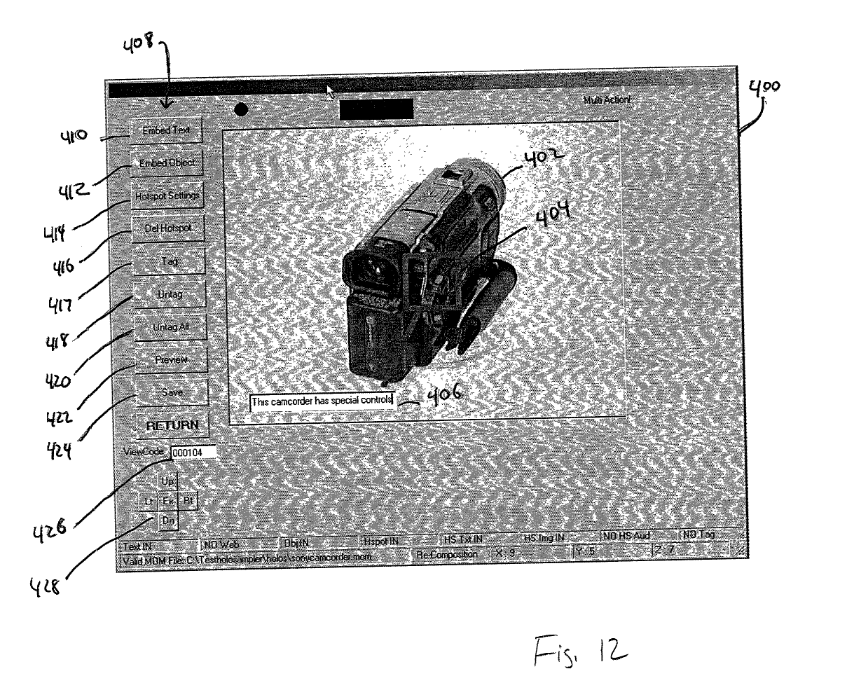

With each hot spot, a control action can be associated. When the user moves the mouse or clicks the mouse in a hot spot region, a control action is initiated. This control action, called a hot spot trigger, will execute a specified set of events. The action triggered could result in displaying or presenting any of the external meta-data or internal meta-data. As shown in FIG. 12, which is a screen print out 400 of a GUI of the composer of the present invention, a video camera 402 is shown with a hot spot trigger 404 which is highlighting certain controls of the camera 402. When the viewer clicks on the hotspot trigger, the code embedded at that position in the MIM data file causes the window 406 to appear, which gives further information about the controls. As set forth above, the hotspot could be linked to audio files, video files and graphics files, as well as text files.

Also shown in FIG. 12 is a menu bar 408 which enables an operator to insert the different types of hot spots into an image matrix. Button 410 enables the operator to embed text, such as in window 406 into the image. Similarly, button 412 enables the operator to directly embed an object, such a graphics file, video files, etc. into the image. Button 414 enables the operator to choose setting for the hotspots, such as the form of the hotspot, such as square 404. Other options include the color and size of the hotspot. Buttons 417-420 enable the operator to tag certain portions of the image with meta-data that is not activated until triggered. Button 422 enables the operator to preview all of the embedded and tagged hotspots and button 424 enables the operator to save the image with the embedded and tagged hotspots. Window 426 shows the code of the image that is being manipulated. The code sequence is described in detail below. Finally, navigation buttons 428 enable the operator to navigate between images in the image matrix, as is described in detail below.

Meta-data must be embedded along with the main image matrix data. This embedding is referred to as encapsulation. In other words, all meta-data and image data are contained in a single .hlg file. Meta-data encapsulation can occur in two forms. In direct encapsulation, all meta-data is included in the image data. In indirect encapsulation, only path information where the actual data is stored is included. The path information could be a URL. Preferably, the sign of data length determines the nature of encapsulation. If the sign of the chunk length is positive, then direct encapsulation is used and the actual data is contained within the image data file. On the other hand, if the sign of the chunk length is negative, then the data location is only pointed out in the file.

As set forth above, each image matrix cube is a 3-D array of images captured from the scanner 12 with its associated meta-data. In order to facilitate the identification of each of the images in the matrix cube, a naming convention for the images is as follows: Every image is denoted by concatenation of three numbers <a><b><c> where:

a can be a number between 0 and Z−1 denoting multi-action numbering;

b can be a number between 0 and Y−1 denoting camera numbering; and

c can be a number between 0 and X−1 denoting turntable rotation.

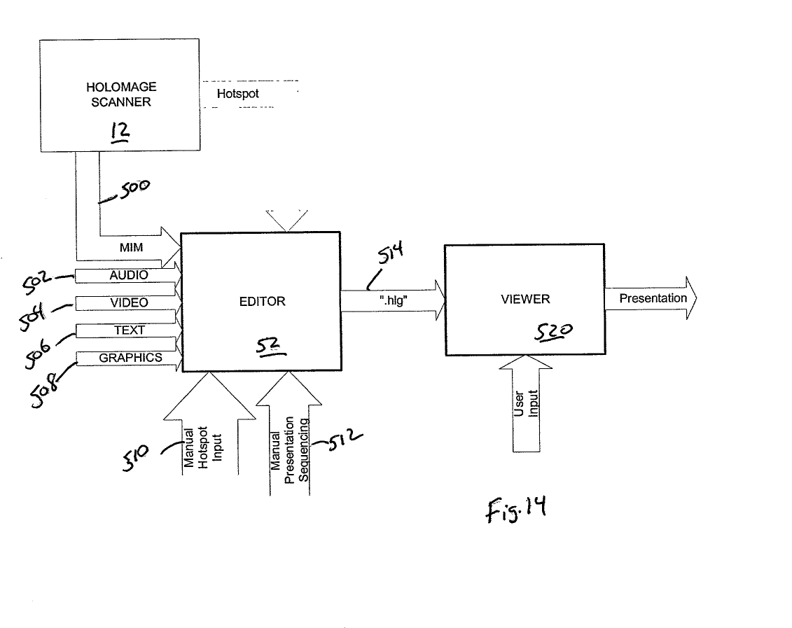

FIG. 13 is a schematic diagram showing an image matrix cube 450 including a number of image matrices. Image matrix 452 includes a number of images, as described above, and illustrates the first image plane where 10 cameras are used and the turntable made 10 degree turns 36 times. The images obtained from the first camera (row 454) are denoted by:

Image 000000

Image 000001 . . .

Image 000035.

The images from the second camera (row 456) are:

Image 000100

Image 000101 . . .

Image 000135.

The first two digits represent the Z-axis (multi-action and zoom), the second two digits represent the camera and the last two digits the angle of the turntable. By extension, for the second image plane, the following set of images will apply:

Image 010100

Image 010101 . . .

Image 010135.

Referring again to FIG. 16, in the file nomenclature set forth above, image 710 would be referred to in the code as image 000201; image 716 would be referred to as image 000301; image 712 would be referred to as image 000302; and image 714 would be referred to as image 000404.

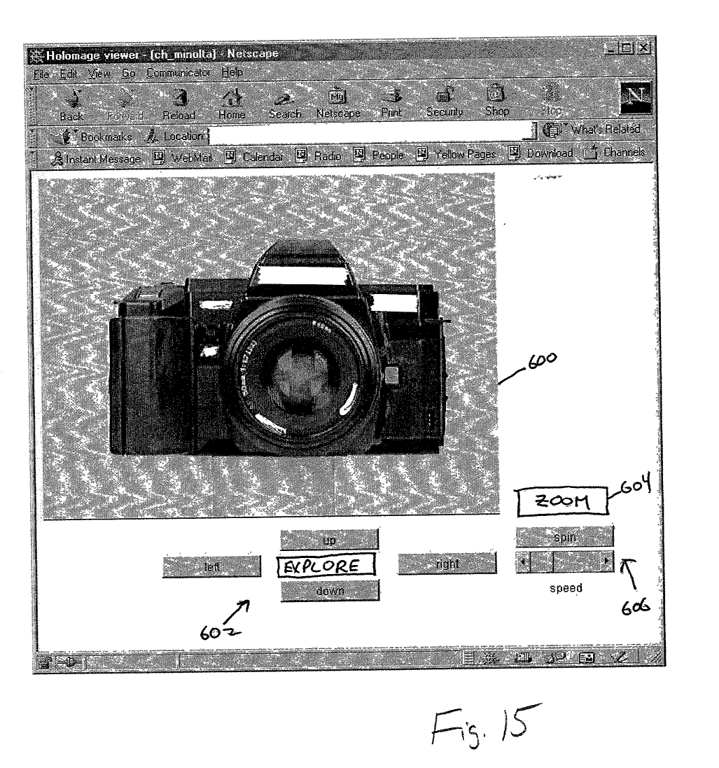

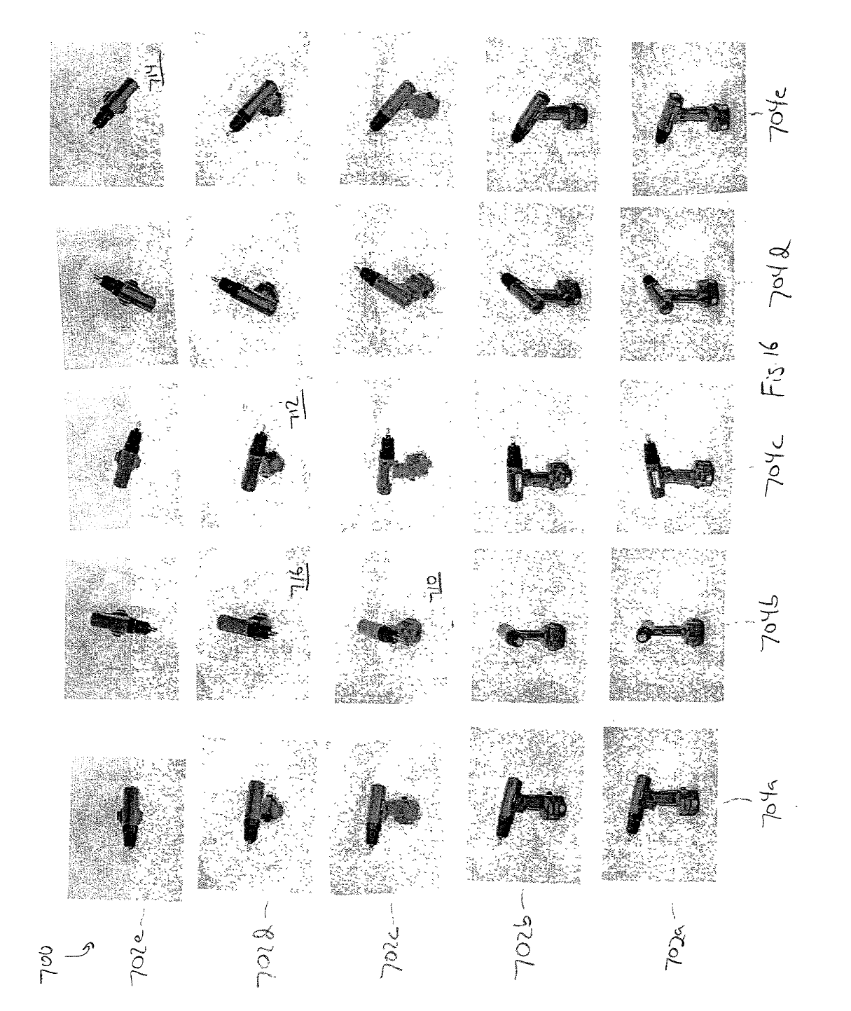

FIG. 14 is a schematic diagram of the editor 52. As shown in the figure, editor 52 is the portion of the editor suite 50 which receives the MIM file 500 from the scanner 12 and the audio 502, video 504, text 506 and graphics 508 stream files from an associated computer (not shown), as well as a manual hotspot input 510 and manual presentation sequencing 512. Editor 52 compiles the received data and outputs a “.hlg” file 514, as described above, to the viewer 520, which may be a personal computer incorporating a browser for viewing the data file as received over the network 42, for enabling the operator to view the resulting data file. FIG. 15 shows a screen print out of a GUI of a viewer browser. As seen in the figure, an image 600 is shown in the window of the browser, along with navigation buttons 602.

As described above, the set of images to be displayed is located on the web server 34 or on a file system 62. Each file includes an applet which renders images based on the camera location around an object. These images are retrieved when the applet starts and remain in memory for the duration of the applet's execution.

The images in the images matrix are referenced in a 3-dimensional space. Dragging the mouse left and right changes the position in the X axis. Dragging the mouse up and down changes the position in the Y axis. Holding the control key and dragging the mouse in up and down changes the position in the Z axis.

Image index formula

The images are loaded into a one-dimensional array at the beginning of the session. The formula for determining the image index from the 3-D position (X, Y, Z) is as follows:

index=z*(width)*(height)+y*(width)+x.

Applet initialization

When the applet starts up, it begins loading the images one at a time, and displays the currently loaded image at preferably ½ second intervals. Once it is done loading all the images, it is ready to accept user input.

User input

The user controls the (simulated) rotation of the object, as well as the current multi-action view, and the zoom. In the code, there exists a 3-dimensional space containing x, y, and z axes. Each discrete position in this 3-dimensional space corresponds to a single image in the matrix image set. The applet keeps track of the current position using a member variable. Based on the current position, the corresponding image is rendered. The user can change the current position in the 3-dimensional space by either dragging the mouse or clicking the navigation buttons 602 in the GUI.

Accordingly, the applet takes input from the user in two forms:

1. Mouse dragging—By dragging the mouse left and right, the current position in the x-axis is changed, thereby simulating a rotation in the horizontal plane. By dragging the mouse up and down, the current position in the y-axis is changed, thereby simulating a rotation in the vertical plane. By holding the Control key down and dragging up and down, the current position in the z-axis is changed, thereby selecting a different multi-action view, if any exist.

2. Buttons—four buttons for navigation exist; five if there are multiple multi-action views. Buttons labeled “left” and “right” change the position in the x-axis by one image increment. Buttons labeled “up” and “down” change the position in the y-axis by one image increment. The button labeled “Explore” changes the position in the z-axis by one, thereby selecting a different set of multi-action views.

Referring to FIG. 16, if a viewer who is viewing image 710 of matrix 700 drags the mouse upward or clicks the “up” button, FIG. 15, the system replaces image 710 with image 716 in the browser. Then, if the viewer drags the mouse to the right or clicks the “right” button, the system replaces image 716 with image 712. Accordingly, it will be understood that, by utilizing several cameras and capturing images at several angles of rotation, the object can be made to seamlessly rotate in three dimensions. Greater numbers of cameras and capture angles of rotation will increase the seamless nature of the rotation of the object.

Image rendering

All images loaded are stored in memory as an object of class java.awt.Image. The current image (based on the current position in the 3-dimensional space) is drawn to the screen using double buffering in order to achieve a smooth transition from one image to the next. The fact that all images are kept in memory also helps the applet to achieve the speed required for fast image transition.

Image file retrieval

Images are loaded either from the web server 34 or from the file system 62, based on the “img” parameter passed to the applet. If the images are on a web server, the protocol used is standard HTTP using a “GET” verb. The applet uses its getimage method to retrieve the image object, regardless of whether it exists in a file on the local disk or if it exists on the web server.

Zoom

A zoom button 604 enables the user to drag a rectangle over the currently displayed image. The applet then takes the area enclosed in the rectangle and expands the pixels to fit an area the same size as the original image. It performs smoothing using a filtering algorithm. The filtering algorithm is defined in ZoomWindow.java, in the class ZoomImage.Filter, which extends Java's ReplicateScaleFilter class. Finally, it displays the zoomed and filtered image in a new pop-up window.

Spin

The spin button and slider 606 in the GUI causes the applet to rotate the model in the x (horizontal) axis. The slider allows the user to control the speed at which the model rotates. In the code, a separate thread is used to change the current position in the 3-dimensional space. It executes the same code as the user's input would, thereby allowing the code to follow the same rendering path as it would if the user were dragging the mouse or pressing the navigation buttons.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

1. A system for generating at a client location, an image representative of a view of an object, comprising:
A. an image capture system for generating a plurality of image data sets associated with an object at an image capture location, each of said image data sets being representative of an image of said object as viewed from an associated image capture viewing angle;
B. an image processor for transforming said image data sets to a matrix data set, said matrix data set being representative of said plurality of image data sets;
C. a client processor;
D. means for transmitting said matrix data set to said client processor, wherein said client processor is responsive to a user specification of a user-specified viewing angle, for generating client view data from said matrix data set, wherein said client view data is representative of an image of said object viewed from said user-specified viewing angle; and
E. a client display at said client location responsive to said client view data to display said object.

2. A system according to claim 1 wherein said user-specified viewing angle is selected independently of said image capture viewing angles.

3. A system according to claim 1 wherein said user-specified viewing angle coincides with one of said image capture viewing angles.

4. A system according to claim 1 wherein each of said image capture viewing angles has coordinates along both a longitudinal axis and a latitudinal axis around said object.

5. A system according to claim 1 wherein said transmitting means effects data transmission over a communication path.

6. A system according to claim 5 wherein said communications path is a wired path.

7. A system according to claim 6 wherein said communications path is one of the group consisting of a LAN, a WAN, the internet and an intranet.

8. A system according to claim 5 wherein said communications path is a wireless path.

9. A system according to claim 8 wherein said communications path is one of the group consisting of a LAN, a WAN, the internet, and an intranet.

10. A system according to claim 1 wherein said transmitting means effects transfer of said matrix data set resident on a storage medium.

11. A system according to claim 10 wherein said storage medium is from the group consisting of a hard disk, a floppy disk, CD, a memory chip.

12. A system according to claim 1 wherein said matrix data set further includes multimedia data and/or links to Internet sites associated with said object

13. A system according to claim 1 further comprising a matrix controller for effecting the generation of multiple matrix data sets for said object, each of said matrix data sets being representative of a plurality of image data sets generated for said object in a different state.

14. A system according to claim 1 wherein said client processor includes a view generating computer program adapted to control said client processor to generate said client view data from a received matrix data set.

15. A system according to claim 14 wherein said matrix data set further includes at least a portion of said view generation computer program.

16. A system according to claim 1 wherein said matrix processor effects a compression of said matrix data set prior to transmission to said client processor.

17. A system according to claim 16 wherein said client processor effects decompression of a received compressed matrix data set.

18. A system according to claim 12 wherein said matrix processor effects a compression of said matrix data set prior to transmission to said client processor.

19. A system according to claim 18 wherein said client processor effects decompression of a received compressed matrix data set.

20. A system according to claim 15 wherein said matrix processor effects a compression of said matrix data set prior to transmission to said client processor.

21. A system according to claim 20 wherein said client processor effects decompression of a received compressed matrix data set.

22. A system according to claim 1 wherein a portion of at least one of said image data sets which is representative of a predetermined surface region of said object is associated with a predetermined action, said association being defined in said image data sets.

23. A system according to claim 22 wherein said client processor is operable in response to a user selection of a portion of said displayed image which corresponds to said predetermined surface area of said object, to effect said predetermined action.

24. A system according to claim 13 wherein a portion of said image data sets representative of predetermined surface region of said object is associated with a predetermined action, said association being defined in said image data sets.

25. A system according to claim 24 wherein said client processor is operable in response to a user selection of a portion of said displayed image which corresponds to said predetermined surface area of said object, to effect said predetermined action.

26. A system according to claim 25 wherein said predetermined action is to generate said display based on client view data from a different matrix data set.

27. A system according to claim 1 wherein said matrix data sets further include non-image data.

28. A system according to claim 27 wherein said non-image data includes data relating to attributes of said object.

29. A system according to claim 27 wherein said non-image data includes data that points said client processor to a database that includes attribute data of said object.

30. A system according to claim 20 wherein said client processor includes means for modifying said predetermined action.

31. A method of determining an optimal focus setting of a camera having a minimum focus setting value fₘᵢₙ and a maximum focus setting value fₘₐₓ to an optimum focus setting value comprising:
A. setting a focus setting of said camera to said minimum focus setting value fₘᵢₙ;
B. capturing an image of an object with said camera;
C. computing the value of the Y-component of the image;
D. counting the number of pixels along an edge of the Y-component of the image;
E. storing the edge pixel count associated with the image;
F. increasing the focus setting by a predetermined amount Δf;
G. repeating steps B-F until the focus setting equals the maximum focus setting value fₘₐₓ;
H. identifying the image having the greatest edge pixel count; and
I. identifying the focus setting corresponding to the image identified in step H as the optimal focus setting.

32. A method for adjusting the gain of each of a plurality of cameras in an array of cameras aimed at a common point in order to balance the intensity of images captured by each of the cameras in the array comprising:
A. capturing an image with each of said plurality of cameras;
B. determining an intensity associated with each image;
C. identifying an image having the highest intensity Iₘₐₓ of the plurality of images and an image having the lowest intensity Iₘᵢₙ of the plurality of images;
D. determining if the difference between Iₘₐₓ and Iₘᵢₙ exceeds an intensity threshold;
E. increasing the gain of the camera that captured the image having the lowest intensity Iₘᵢₙ by a predetermined amount;
F. repeating steps A-E until, in step D, the difference between Iₘₐₓ and Iₘᵢₙ does not exceed said intensity threshold.

33. A system for creating a multi-dimensional image comprising:
a plurality of cameras arranged in an array:
a turntable device adapted for receiving an object thereon and including a motor for turning the turntable;
a camera control device for controlling said cameras; and
a motor control device for controlling the operation of the motor;
wherein each of said plurality of cameras captures an image of the object at differing angles of rotation of said turntable to form an X by Y image matrix containing (XY) images, where X represents a number of degrees of rotation of said turntable and Y represents a number of said cameras.
